(19) United States
(12) Patent Application Publication
(10) Pub. No.: US 2016/0300318 A1
(43) Pub. Date: Oct. 13, 2016

(54) FARE DETERMINATION SYSTEM FOR ON-DEMAND TRANSPORT ARRANGEMENT SERVICE

(71) Applicant: Uber Technologies, Inc., San Francisco, CA (US)

(72) Inventor: Hasrat Godil, San Francisco, CA (US)

(21) Appl. No.: 15/098,295

(22) Filed: Apr. 13, 2016

Related U.S. Application Data
(60) Provisional application No. 62/146,945, filed on Apr. 13, 2015.

(51) Int. Cl. G06Q 50/30; G06Q 10/06; G07B 15/00; G06Q 10/02

(52) U.S. Cl. CPC G06Q 50/30; G06Q 10/02; G06Q 10/063114; G07B 15/00

(57) ABSTRACT

A fare is predictively determined for a group transport based on a transport input of a user. The transport input includes information that indicates at least one of a pickup or drop-off location. At least one trip for the transport input is determined. A group price is determined for the trip based on a probability of a group size for the group transport for one or more segments of the at least one trip. At least one fare is determined for the at least one trip based on the group pricing factor. The at least one fare is communicated to the rider in advance of the rider receiving a transport request.

### RELATED APPLICATIONS

This application claims benefit of priority to U.S. Provisional Patent Application No. 62/146,945, filed Apr. 13, 2015; the aforementioned priority application being incorporated by reference in its entirety.

### BACKGROUND

Transport services are increasingly becoming more diverse and common, particularly with advances in location-dependent services. Many such services enable individual users to request transportation on demand. For example, transport services currently exist which enable vehicle drivers to provide transport for other potential passengers in a transport pooling arrangement.

### BRIEF DESCRIPTION OF THE DRAWINGS

FIG. 1 determines a fare determination system for a transport arrangement service, according to one or more embodiments.

FIG. 2 illustrates an example method for determining a fare for a group transport, according to one or more embodiments.

FIG. 3 illustrates an example method for determining fares for candidate trips of a given rider in response to a transport input, according to one or more embodiments.

FIG. 4A illustrates an example of a rider interface for selecting a transport type, according to one or more embodiments.

FIG. 4B illustrates an example of a rider interface for displaying a fare for group transport, according to one or more embodiments.

FIG. 5 is a block diagram that illustrates a computer system upon which embodiments described herein may be implemented.

FIG. 6 is a block diagram that illustrates a mobile computing device upon which embodiments described herein may be implemented.

### DETAILED DESCRIPTION

Examples described provide a system and service in which a fare is predictively determined for a group transport service. As described with numerous examples, the group transport service includes a transport service (also referred to herein as a trip) offered to a rider in which more than one rider, pickup location and/or drop-off location may be included with the provided transport service. Examples as described use predictive determinations in order to anticipate a group size of a transport service provided to the user, even under assumptions which provide for the group size to fluctuate along a trip for which a fare determination is being made.

In some examples, a fare is predictively determined for a group transport based on a transport input of a user. The transport input includes information that indicates at least one of a pickup or drop-off location. At least one trip for the transport input is determined. A group price is determined for the trip based on a probability of a group size for the group transport for one or more segments of the at least one trip. At least one fare is determined for the at least one trip based on the group pricing factor. The at least one fare is communicated to the rider in advance of the rider receiving a transport request.

In another variation, a transport input includes an inference or indication of a pickup or drop-off location. Information which includes rider history can be used to determine multiple candidate trips, and the trip information for each candidate trip can be used to determine a fare for the candidate trip. The determined fares can further be adjusted for alternative types of services.

One or more embodiments described herein provide that methods, techniques, and actions performed by a computing device are performed programmatically, or as a computer-implemented method. Programmatically, as used herein, means through the use of code or computer-executable instructions. These instructions can be stored in one or more memory resources of the computing device. A programmatically performed step may or may not be automatic.

One or more embodiments described herein can be implemented using programmatic modules, engines, or components. A programmatic module, engine, or component can include a program, a sub-routine, a portion of a program, or a software component or a hardware component capable of performing one or more stated tasks or functions. As used herein, a module or component can exist on a hardware component independently of other modules or components. Alternatively, a module or component can be a shared element or process of other modules, programs or machines.

Some embodiments described herein can generally require the use of computing devices, including processing and memory resources. For example, one or more embodiments described herein may be implemented, in whole or in part, on computing devices such as servers, desktop computers, cellular or smartphones, personal digital assistants (e.g., PDAs), laptop computers, printers, digital picture frames, network equipment (e.g., routers) and tablet devices. Memory, processing, and network resources may all be used in connection with the establishment, use, or performance of any embodiment described herein (including with the performance of any method or with the implementation of any system).

Furthermore, one or more embodiments described herein may be implemented through the use of instructions that are executable by one or more processors. These instructions may be carried on a computer-readable medium. Machines shown or described with figures below provide examples of processing resources and computer-readable mediums on which instructions for implementing embodiments of the invention can be carried and/or executed. In particular, the numerous machines shown with embodiments of the invention include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on smartphones, multifunctional devices or tablets), and magnetic memory. Computers, terminals, network enabled devices (e.g., mobile devices, such as cell phones) are all examples of machines and devices that utilize processors, memory, and instructions stored on computer-readable mediums. Additionally, embodiments may be implemented in the form of computer-programs, or a computer usable carrier medium capable of carrying such a program.

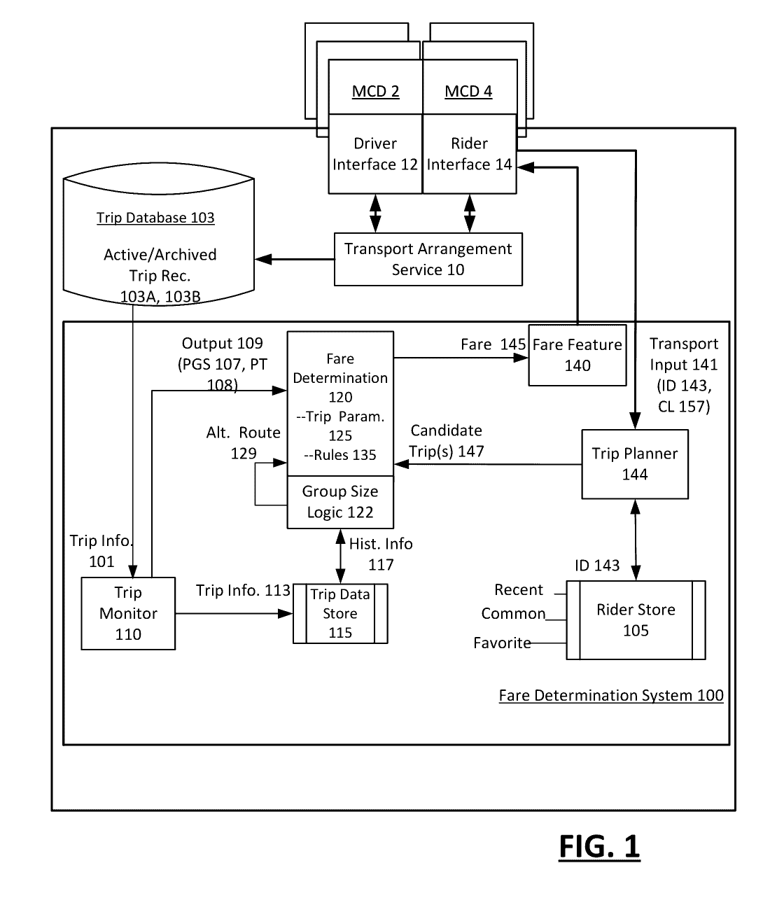

FIG. 1 determines a fare determination system for a transport arrangement service, according to one or more embodiments. A fare determination system 100 such as described with an example of FIG. 1 can operate to determine fare information for users who utilize a transport arrangement service 10 to obtain transport services (e.g., personal transport). According to one aspect, fare information is provided for a prospective trip that is arranged through a network service (e.g., a transport arrangement service). In some example, the fare determination system 100 can determine a fare for a prospective trip with a group transport service.

According to some examples, the system 100 can determine a fare for an actual or prospective trip based on one or more variable factors which may be unknown in advance of when the transport service is requested. In variations, the fare determination component 120 anticipates a trip and determines fares for alternative candidate trips which the user may request. A prospective trip or candidate trip may defer in degrees of predictability with respect to the likelihood that a particular trip is of interest or within the rider's intent. In some examples, a prospective trip is a planned or well defined trip where many, if not all (e.g., pickup and/or drop-off locations of an intended trip are specified by user) of the inputs for a trip are known to a threshold level of certainty (e.g., based on explicit user input). A candidate trip, on the other hand, may be indicated by probability (e.g., a most likely trip given a user's location) based on inferences or input which may not be explicitly understood by a transport arrangement service.

According to one aspect, the transport service may provide a group transport service, for which the fare is based on the number of riders in the vehicle (i.e., the group size). Thus, the fare for a particular group trip may be variable and dependent on factors such as a predicted or actual group size of the prospective trip, and/or a group size of one or more segments that comprise the prospective trip. In such examples, the system 100 may determine a fare for a group transport service in advance of the transport service being requested or initiated. As an alternative or addition, the system 100 may determine a fare for a group transport service provided for a prospective trip (e.g., an unplanned trip, a trip requested without commitment from the rider, a trip that is inferred as being desired, etc.).

According to another aspect, the system 100 includes logic and intelligence for predicting candidate trips for the user based on limited user input. The candidate trips can be determined for purpose of either fare estimation or fare determination. Additionally, in some variations, the fare estimation or determination can be manipulated by the user based on input parameters that specify parameters such as alternative types of service (e.g., vehicle types), or a time when service is provided. In an example of FIG. 1, the fare determination system 100 can be implemented as a network service which communicates with a mobile computing device (“MCD”) of a rider (or prospective rider). Accordingly, the system 100 can be implemented as a network service, provided with or as part of a transport arrangement service 10.

In examples provided below, a “rider” is a user of the transport arrangement service 10. The term is intended to encompass users who are prospective or potential riders in that the individual users receive fare information for a prospective trip or for a set of one or more candidate trips.

In an example of FIG. 1, the fare determination system 100 includes an active trip monitor 110, a trip data store 115, a fare determination component 120, a trip planner 144, and a fare feature 140. In one example, the fare determination system 100 can be provided as part of a transport arrangement service 10 in which riders and drivers are matched so that riders can be provided transport on request (e.g., “on-demand”). In variations such as shown by FIG. 1, however, the fare determination system 100 can operate as an independent service from the transport arrangement service 10. The transport arrangement service 10 can include functionality for enabling riders to operate mobile computing devices 4 in order to receive transport from drivers who are associated with mobile computing devices 2 and/or vehicles.

In some examples, riders operate the mobile computing devices 4 to exchange information with, and access functionality from the transport arrangement service 10. For example, the drivers and riders may each operate mobile computing devices 2, 4 which have respective service applications installed, to enable the respective devices to access information and functionality from the transport arrangement service 10. A service application, as described herein, can be stored and operated on a mobile computing device of a user, and can communicate with the transport arrangement service 10 over one or more networks. In the examples provided, the service applications may provide functionality which includes driver interface 12 and rider interface 14. The rider may operate the mobile computing device 4 to enter input via the service application, which can communicate data about the input to the transport arrangement service 10 via the rider interface 14. The input may correspond to the rider requesting a transport service, the rider making a pre-request for a transport service, the rider launching the application or the rider performing some interaction that inferentially indicates the user is interested in requesting a transport service. When the rider makes a transport request, the transport arrangement service 10 selects an available driver (or vehicle) for the rider, and then communicates the location of the rider to the driver.

From the perspective of the driver, the drivers operate service applications of mobile computing devices 2 to exchange driver-centric information with the transport arrangement service 10. Additionally, the transport arrangement service 10 can provide functionality for facilitating drivers in arriving at pickup or drop-off locations. The transport arrangement service 10 may select drivers for individual transport requests based on factors such as proximity and availability of the drivers. Once a driver is selected for a transport request, the driver can be provided the pickup location, and tracked (e.g., by receiving location data from a global positioning system (“GPS”) resource of the driver's mobile computing device 2) from the pickup location to the drop-off location.

According to some examples, the transport arrangement service 10 determine a position of individual riders once the riders open or launch the service application on their respective mobile computing device 4. Each rider may be associated with a current location and a state. By way of example, rider states can correspond to (i) a rider who make a transport request, (ii) a rider who is just about to request transport, (iii) a rider who is awaiting (or meeting) a driver who is en route to a pickup location, and (iv) a rider who is receiving transport. The rider interface 14 (e.g., programmatic processes run on the rider mobile computing device 4) may transmit information to the transport arrangement service 10 corresponding to, for example, the rider's account identifier, the rider's current location (e.g., which can be obtained through the GPS resource of the rider's mobile computing device) and the rider's current state.

In similar fashion, the transport arrangement service 10 determines a position of individual drivers when the drivers make themselves available to the service. Each driver may be tracked, which can be obtained from the GPS resource of the driver's mobile computing device 2. Additionally, drivers can be associated with a driver state, which can correspond to (i) an open state, where the driver has no pending ride request, (ii) a pending state, where the driver has been assigned a transport request but has yet to pick up the rider, (iii) an occupied state, where the driver is transporting a rider, (iv) a near complete state, where the driver is near completion of a trip; and/or (vi) a complete state, after the driver has completed a transport request. The driver interface 12 (e.g., programmatic processes run on the driver mobile computing device 2) may transmit information to the transport arrangement service 10 corresponding to, for example, the driver's account identifier, the driver's current location (e.g., which can be obtained through the GPS resource of the driver's mobile computing device) and the driver's current state.

With reference to an example of FIG. 1, the trip monitor 110 can operate to detect and parse trip information 101 from records of active trips 103A in which transport is being provided through the transport arrangement service 10. The trip monitor 110 can parse trip information 101 in either real-time or asynchronously, in order to determine information about recent trips (e.g., within same day or week) and/or in-progress trips of riders in a given population. The trip monitor 110 can obtain information for a specific geographic region, such as determined through a geographic fence. Alternatively, the trip monitor 110 can associate the acquired trip information 101 with a geographic region. Among other information, the trip monitor 110 can also parse active or archived trip records 103 of arranged transports for pickup locations, drop-off locations, time when transport was provided, and/or type of transport service provided. Additionally, the trip monitor 110 can parse trip information for group transport services to identify segments of each active or archived group transport trip, as well as a group size of each segment. The trip monitor 110 can store the parsed trip information 113 with the trip data store 115. Collectively, the trip data store 115 can provide historical information 117 for a select period of time, such as information that identifies the pickup and drop-off location of trips with the geographic region, the time when such trips were provided within the geographic region, and the group size (or number of passengers) of segments of the individual trips for the select period of time. In this way, the trip data store 115 can store (i) information that is indicative of a demand for a transport service in a given time period and/or at a given location within the geographic region, (ii) information that is indicative of demand for a particular type of transport service, and/or (iii) historical information that is predictive of a number of group riders (i.e., riders who request group transport), including pickup times and pickup/drop-off locations of such riders. Among other variations, the trip data store 115 can also include transport provided by a particular type of vehicle and/or group transport service, as well as the number of open transport requests which require fulfillment at different times of the monitored duration. In a given time period, the information that is indicative of demand can be determined from, for example, a number of actual requests and/or a number of riders who make such requests being located in a given geographic region.

According to some examples, a rider's transport input 141 can be detected and communicated to the system 100 via the rider interface 14. The fare feature 140 can be implemented as, for example, a network side process that communicates information to the rider interface 14 (e.g., via the service application running on the rider device). The transport input 141 can be processed by trip planner 144, which determines trip information for one or more trips which are indicated by the transport input 141. In one aspect, the transport input 141 includes both pickup and drop-off locations, in which case the trip information is well defined and passed on by the trip planner to the fare determination component 120.

In another aspect, the transport input 141 may specify or infer only a pickup location, and omit a drop-off location. For example, the transport input 141 can correspond to the user opening (on the rider's mobile computing device) a service application for the transport arrangement service and/or the user specifying a pickup location, without providing any additional input to specify a drop-off location. In another example, the transport input 141 can correspond to an explicit request from the user for transport between a pickup and drop-off location. In a variation, the transport input 141 can correspond to an inference or action that transport is desired or will be requested, with at least the drop-off location being unspecified. By way of example, the inference can be based on a user action, such as (i) the rider opening, launching or refreshing the service application on the rider's computing device for a transport arrangement service, (ii) the rider being located at or near a known pickup location for that rider when the service application is running on a mobile computing device 4 of the rider, and/or (iii) the rider requesting a transport at a specified pickup location without specifying the drop-off location. In this way, the transport input 141 can be utilized by the system 100 to generate fare information in advance of the user making an explicit transport request or receiving a transport service.

According to an embodiment, the trip planner 144 receives the transport input 141 and references information about the transport input 141 (e.g., identity of the rider, the time of day, day of week) against the rider's historical activity. In some examples, the transport input 141 can identify a user account 143 and a user's current location 157. In particular, system 100 may maintain or access a rider data store 105 which maintains information regarding the historical trip activity of individual riders. For example, the rider's mobile computing device 4 can send the account identifier 143 to identify the rider or rider account, and the identifier can be referenced against a library of rider data stores to determine the rider data store 105 for the particular rider. The rider data store 105 can be used to determine likely sets of relevant locations, including destination or drop-off locations for a candidate or prospective trip, such as (i) a set of recent drop-off locations of the rider, (ii) a set of most common drop-off locations of the rider, and/or (iii) a set of favorite drop-off locations of the rider. In determining the likely locations, the trip planner 144 can utilize, for example, the current location 157 of the rider as a proximity filter for determining relevant locations from the rider data store 105.

The trip planner 144 can determine one or more candidate trips 147 for the transport input based on the transport input 141 and the rider data store 105. In particular, the trip planner 144 can determine candidate trips 147 as between each likely or known pickup location and each likely drop-off location. In determining candidate trips 147 for fare estimation/calculation, the trip planner 144 may use inferential input, such as sensor input provided with the transport input 141 which indicates the user is interested in making the ride request.

The fare determination component 120 identifies trip parameters 125 from the candidate trips 147 in order to determine one or more fares for a corresponding prospective trip of the rider. The trip parameters 125 define variables which may directly or indirectly affect a fare for a trip. For a given trip (e.g., prospective or candidate trip), the trip parameters 125 may include one or more of (i) a distance of the trip, (ii) a time for the trip to be completed, (iii) a type of vehicle used for the trip, (iv) historical information that indicates demand for transport services (or type of transport service) provided through the transport arrangement service 10, based on a geographic and/or timing parameter, and/or (v) a current estimate of demand as based on information such as the number of open or unfulfilled ride requests, the number of users who have the service application open, and/or the number of available drivers. Additionally, when group transport is to be arranged, the fare determination component 120 can factor in a reduction based on a predicted or desired group count for the trip or segments thereof. The trip parameters 125 can be determined in advance of the rider making a request for transport. For example, the trip parameters 125 can be determined when the user launches the application, or when the user interacts with the service application or otherwise performs some action that is indicative of the user viewing the display and content from the service application. Still further, the trip parameters 125 can be determined when the user provides input for a pre-request. For example, the user can enter input for a fare estimate, and optionally specify one or more trip parameters 125, or have the trip parameters determined through inference (e.g., analysis of user history).

Accordingly, in one example, trip parameters 125 are determined for a known prospective trip (e.g., rider specifies both pickup and drop-off locations). The prospective trip can be identified from, for example, a pre-request for a transport service, or alternatively, from user interaction which is indicative of the user intent to request transport. Still further, the user can submit a transport request to determine the fare 145 based on the trip parameters 125, in which case the user may cancel the transport request once the fare 145 becomes known. Once determined, the fare 145 can be incorporated as content for the fare feature 140, which can be rendered on the rider interface 14 (e.g., display screen of mobile computing device). In variations, multiple fares 145 can be determined for a prospective trip, with each fare providing a variation for factors such as vehicle or service type.

Still further, in some examples, the trip parameters 125 are determined for a set of one or more candidate prospective trips. The prospective trips include those trips in which at least one of the pickup location or drop-off location is unknown. The fare determination component 120 can determine the fare 145 for each candidate trip 147 based on a predetermined methodology, which can factor in the trip parameters 125 for each trip.

According to one aspect, when group transport is to be arranged, the trip planner 144 can determine multiple segments for each trip, whether the trip is a prospective trip or a candidate trip. The fare determination component 120 can include a group size logic 122 which can operate to predict a group size (or to determine probabilities of alternative group sizes) of the prospective trip for purpose of determining a discount or group determined fare for the trip. In one implementation, trip planner 144 identifies segments of each trip associated with a particular transport input 141. For each segment, the group size logic 122 determines a probable group size (or probabilities of alternative group sizes), which can include consideration of one or more of the following scenarios: (i) the rider is picked up as a solo passenger after requesting a group transport, and then additional riders are added to the transport vehicle with corresponding trips that overlap the existing trip of the rider, or (ii) the rider is picked up as an additional passenger to a group transport that is in progress, and the rider's trip overlaps in part or in whole with the existing trip of the group transport.

In determining the probable group size, route reconfiguration can also factor in for each trip in order to expand the group size without exceeding a threshold limit as to an increase in the trip duration or trip length as compared to a non-group trip. In one implementation, the group size can vary between 1 and 4 riders. In variations, the group size can vary between 1 and 3 riders, or between 1 and 2 riders. Under conventional approaches, pricing for group transport can decrease for each rider of a group as the size of the group is increased. However, in an example of FIG. 1, the arranged group transport service may have different sets of riders in different segments of the trip. For example, the user may initiate the trip as a single rider, and a second rider may join the trip for a portion of the trip. Likewise, a third rider may join for another portion of the trip, and the second and third drivers may overlap. Rather than convey uncertainty as to price to the user, system 100 includes the group size logic 122 to implement a probabilistic approach to estimate a probability of group size for individual segments of each trip that is made under a group transport request. The group size logic 122 can also plan on acceptable route deviations (e.g., routes which differ from an optimal route by less than a threshold time or distance) which may increase total transport time and/or distance based on increasing the probability of achieving a greater group size for at least a portion of the prospective trip. Accordingly, an output 109 of the group size logic 122 can include (i) a predicted group size 107, and (ii) an indication of the portion of the trip which is affected by the group size 108. For example, the output of the group size logic 122 can identify an average group size for a planned trip of the rider, with average group size indicating that only a portion of the overall trip as an additional rider.

As an addition or alternative, the output 109 of the group size logic 122 can also identify an alternative route 129 or route segment for a planned trip, in order to increase a probability of increasing the group size for a planned trip. The alternative route 129 may provide a basis for determining the fare for the planned trip, but the arranged transport may utilize another route when the transport is provided. For example, the transport provider may follow an optimal route for a trip, as calculated from duration of time and/or distance, when only the original rider is in the vehicle. In such cases, the optimal route may differ from the anticipated or predicted route which may form the basis of the fare determination for group transport. According to some implementations, the driver's actual deviation from the optimal route may be based only on compatible group transport requests being received during a time period which can be accommodated by the rider's planned or in-progress trip.

The fare determination component 120 can determine the fare 145 for the arranged transport service, based on the group size determination for the trip, and the portion of the trip which is expected to be affected by additional riders. The fare determination component 120 can also determine the fare 145 for the arranged transport service based on the alternative route 129, which may be predicted for purpose of increasing the group size of the transport. According to one aspect, the fare determination component 120 determines the fare 145 for a group transport using an optimization process that seeks to increase revenue from a group transport request at cost of convenience to the individual or collective group of riders.

Still further, the fare determination component 120 can include a rule set 135 which influence or determine the fares 145 for trips in which group transport is provided. As such, the fare 145 for the group transport can be subject to rules or limits. For example, one rule may provide that the group transport fare cannot be greater than 80% of the anticipated non-group fare. Another rule may provide that the group transport fare must assume, for purpose of a price ceiling, at least one additional rider for at least a majority of the ride.

In some variations, the trip planner 144 determines multiple fares for a given transport input 141, with each fare being for a different type of transport. For example, the rider's transport input 141 can result in the fare determination component 120 generating separate fares 145 for transport provided by different vehicle types and/or through a group transport request. With examples specific for group transport, the trip planner 144 can determine multiple fares for multiple types of group transport services which may be offered through the transport arrangement service 10. For example, the group transport service offered can vary by vehicle type, and/or by number of persons in the requester's party (e.g., two persons entering with requester). In the latter example, the group transport can include a group of riders, of which at least two enter the vehicle independently of one another (e.g., at different times once a trip progresses for one rider).

Still further, the trip planner 144 may determine multiple fares for each candidate trip that the rider may take, based on information determined from the transport input 141. For example, if the transport input 141 identifies the current location of the rider, a separate fare may be determined as between the current location (as pickup location) and each candidate drop-off location (e.g., one or more favorite drop-off locations, a most recent drop-off location and/or a most-frequent drop-off location). The fares for the candidate trips 147 may also be adjusted based on the service type (e.g., vehicle type, group transport, etc.) that the user selects for viewing in advance of requesting transport.

As noted with some examples, the fare(s) 145 determined by the fare determination component 120 can reflect an actual price for a group transport service that is being offered. The fare 145 can be predetermined and offered to the rider, for example, in advance of the rider making a transport request or alternatively, accepting a transport at the pickup location. In variations, the fare(s) 145 can be estimates or binding estimates (e.g., final price will be no greater than fare 145). In such examples, the fare 145 can have an expiration time, after which if the transport request is made, the fare 145 will need to be recalculated. As an addition or alternative, when the fare 145 is binding, the fare may be valid subject to a condition, such as the location of the rider being static (e.g., within a threshold radius) after a binding fare 145 is provided to the rider.

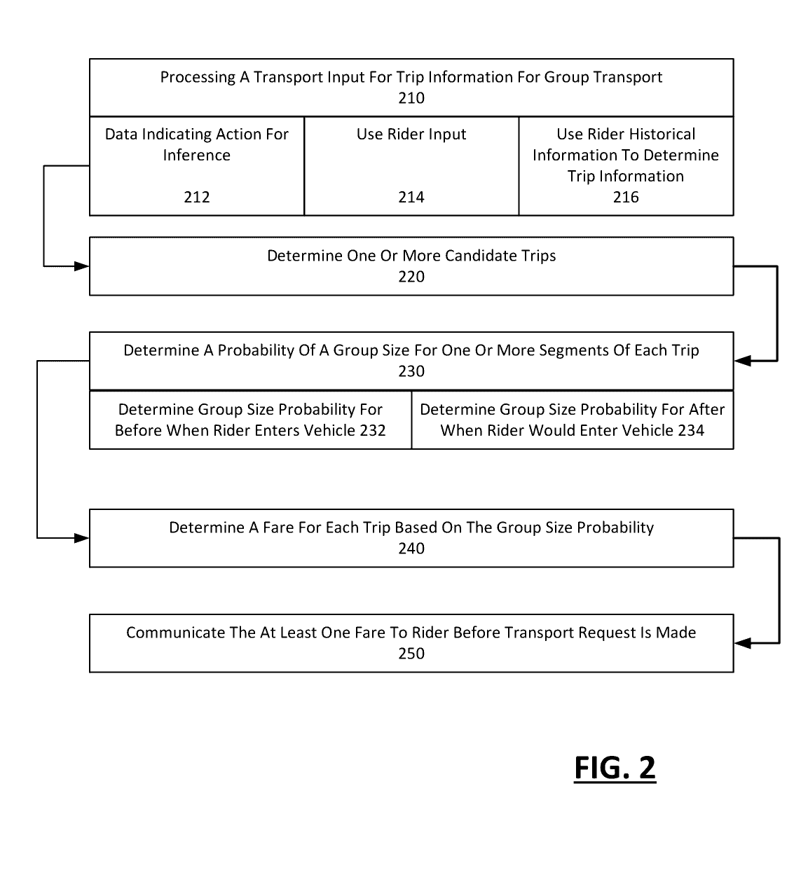

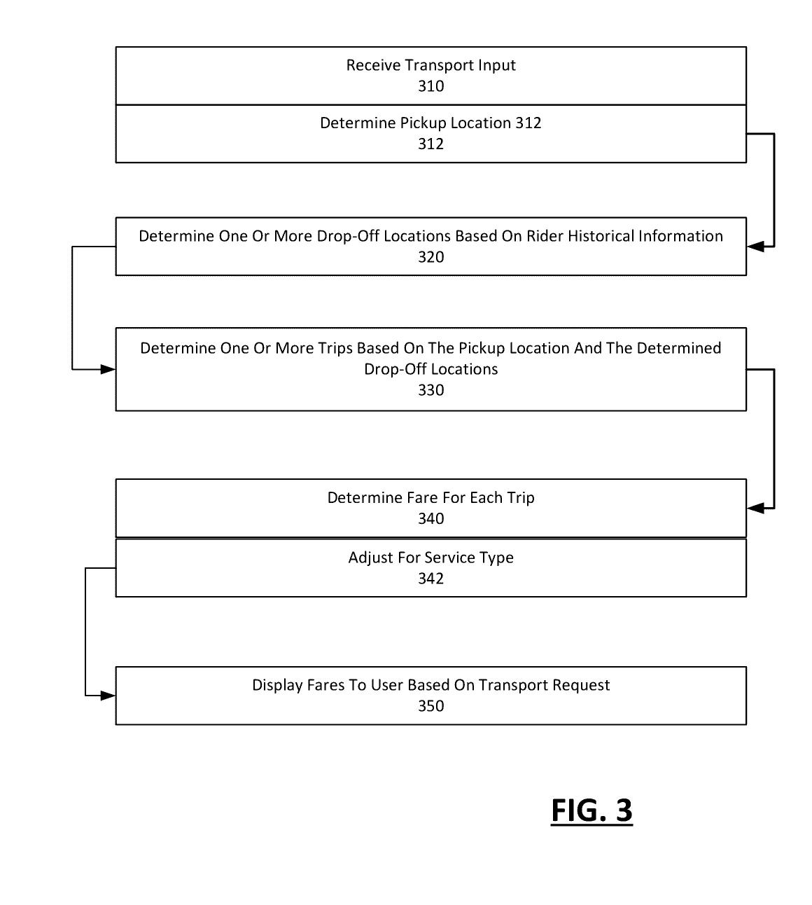

FIG. 2 illustrates an example method for determining a fare for a group transport, according to one or more embodiments. FIG. 3 illustrates an example method for determining fares for candidate trips of a given rider in response to a transport input, according to one or more embodiments. In describing an example of FIG. 2 or FIG. 3, reference may be made to elements of FIG. 1 for purpose of illustrating a suitable component for performing a step or sub-step being described.

With reference to FIG. 2, a transport input is received and processed to determine trip information for a group transport (210). In order to specify a group transport request, the rider may provide input that expressly elects the group transport service. In some variations, the input (e.g., transport input 141) may include data of user actions which are inferential with respect of the user's intent or interest in requesting transport (212). Thus, input can be used to identify user actions, from which the rider's preference or desire to view a group fare price can be inferentially determined. By way of example, the transport input 141 can include data which indicates that the user just launched a service application, or sensor data (e.g., from accelerometer or proximity sensor) which indicates the user is viewing the display screen. The fare determination system 100 can, for example, process a transport request made through a transport arrangement service 10 in order to provide a fare calculation.

As an addition or variation, the trip information can be determined from rider input (214), and/or from historical information maintained about the rider (216). The trip information can also be determined from other sources, such as information pertaining to the general public or class of riders. The trip information determined from the rider input can specify, for example, a pickup location and a drop off location. When the trip information is not explicitly stated by the rider (e.g., by way of a transport request), at least some of the trip information can be inferred. In some aspects, some or all of the trip information can be determined from historical information about the rider, such as information maintained with the rider data store 105. For example, the transport input 141 can specify a pickup location, from which one of multiple possible drop-off locations may be determined. The determination of the drop-off locations for the trip information can be based on historical information about the rider, such as provided from the rider data store 105. As another example, the transport input 141 can indicate multiple possible pickup locations based on the user's current location and one or more drop-off locations.

From the trip information, one or more candidate trips can be determined in response to the transport input 141 (220). When multiple candidate trips are determined from the trip information, each candidate trip may correspond to a candidate trip. While the candidate trips may reflect multiple possible outcomes of varying probabilities, in variations, the trip information can also be based on express user input that specifies the pickup and destination location, so that only one trip is subject to fare determination for group transport.

For each determined trip, a probability is determined for a group size of one or more segments that comprise that trip (230). Each segment may correspond to, for example, a city block, and the probability may determine whether a given transport picks up one or more additional riders along a particular route, or along an alternative route that is within a proximity or time threshold of the optimal route. The probability of the group size for individual segments of each trip may be determined from historical trip information, such as maintained by the trip data store 115. As an addition a variation, the probability of the group size for individual segments of each trip can also be influenced by real time trip information, such as determined by the trip monitor 110 working in connection with group size logic 122.

In some examples, the probability determination of group size includes a determination of whether one or more other users will be present in the vehicle when the trip starts for the particular rider (232). In variations, the probability determination of group size includes a determination of whether the vehicle servicing the rider will receive additional riders once the rider is picked up (234).

A fare can be determined for each trip based on the group size probability, as determined for one or more segments of each trip (240). The determined fare can be subject to various rules and logic, such as (i) a rule that requires the group fare to be less than an optimal non-group fare by a threshold percentage amount, and/or (ii) a rule that requires an assumption that at least one additional rider will be in the vehicle of the trip for at least a majority of the particular trip. Other factors which can weight, influence or otherwise factor into the fare include the type of transport vehicle which is requested or being provided, as well as distance and time for the predicted trip based on the trip information. The distance and time can be determined from either an optimal route (e.g., the route presumably taken for non-group transport), a likely route (e.g., a route taken to pickup an additional rider), or a route add-on (e.g., additional distance that may be traveled in order to pick up another rider). Another factor that can weight, influence or otherwise factor into the fare includes the demand for transport as compared to an inventory of vehicles. The demand can be based on historical information, as well as current information as determined from the trip monitor 110.

Once the fare for the group transport is calculated for each trip, the fare is communicated to the rider (250). For example, the fare feature component may display the fare 145 as content via the rider interface 14 (e.g., service application page). The rider can then elect to receive the transport at the quoted fare. In one implementation, the fare displayed to the rider is fixed and does not change regardless of the number of riders which actually ride on the rider's transport.

With reference to FIG. 3, a transport input may be received or otherwise detected (310). By way of example, the transport input may correspond to the user selecting a pickup location, or alternatively, by way of the user opening an application from which a transport service can be arranged. Depending on variations, the pickup location can be determined or inferred from the transport input (312).

According to one aspect, one or more drop-off locations can be determined for a rider based on rider historical information (320). Thus, the transport input can result in the determination of a pickup location and multiple possible drop-off locations. As mentioned with other examples, the drop-off locations can correspond to favorite locations, most recent drop-off locations, or most common drop-off locations for that rider.

One or multiple trips can be determined for the rider based on the number of drop-off locations (330). Each trip can be viewed as a candidate or possible trip until, for example, a transport request is received for the trip, or for a particular one of the multiple trips.

For each determined trip, a fare can be determined (340). Additionally, each determined fare can be adjusted for service type (342), which in the context of transport services, can include the type of vehicle use, or whether the transport service is a group transport or individual transport. The determined fares can be displayed to the user, so that the user is able to view a price for a transport service to a known destination based on a transport service which indicates a pickup location (350). In some variations, for example, the user can toggle amongst different service levels, with the toggling affecting the price levels which are displayed for multiple possible trips from a current pick-up location to one of multiple possible drop-off locations (e.g., favorite or most common) of the rider.

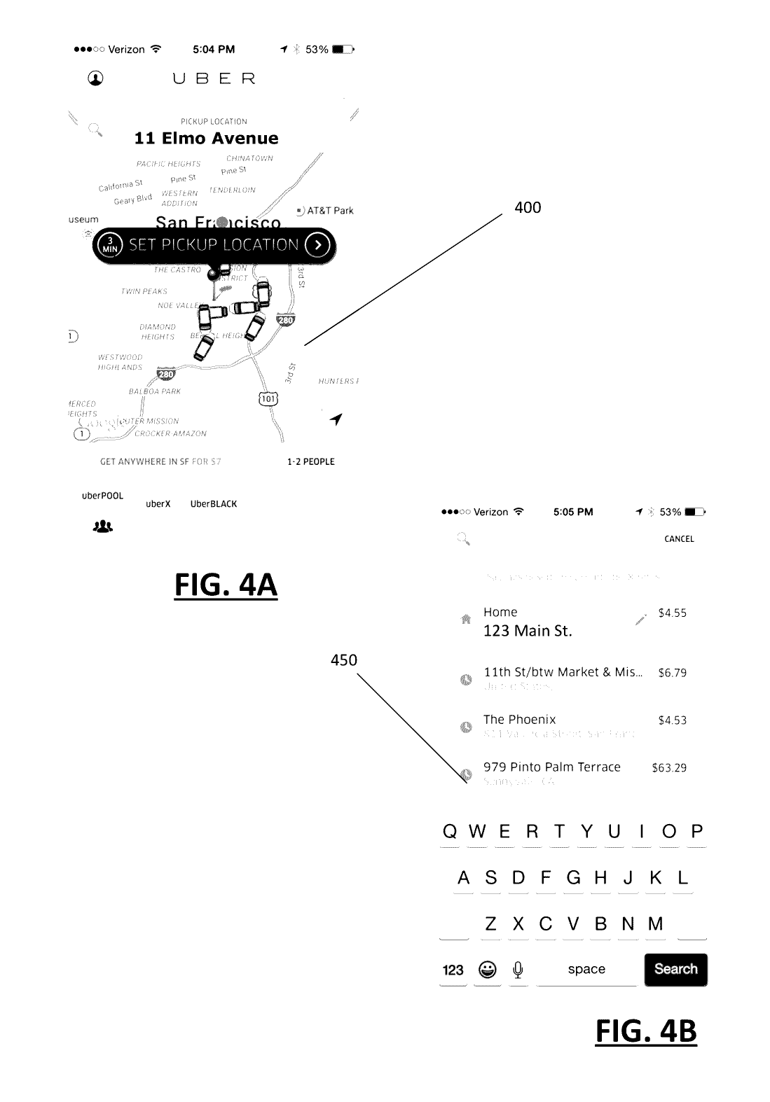

FIG. 4A illustrates an example rider interface 400 for selecting a transport type, according to one or more embodiments. FIG. 4B illustrates an example of a rider interface 450 for displaying a fare for group transport, according to one or more embodiments. Each of FIG. 4A and FIG. 4B can be implemented through, for example, the fare feature 140 of the fare determination system 100. In FIG. 4A, user interface 400 can include a toggle feature that enables the user to select different kinds of service types from which to receive transport services. The toggling of the different service types can yield different fare prices, with the group transport (“pool”) offering the lowest price.

With respect to FIG. 4B, multiple candidate trips may be determined for the user based on different possible drop-off locations. A fare for group transport can be determined for each candidate transport. As the group transport may be assumed the cheapest, an example of FIG. 4B may display each fare for group transport as a comparison with another transport service. In some variations, the user may have favorite locations or may have inputted specific locations to be displayed for possible drop-off locations (e.g., “Home”), such as illustrated in FIG. 4B.

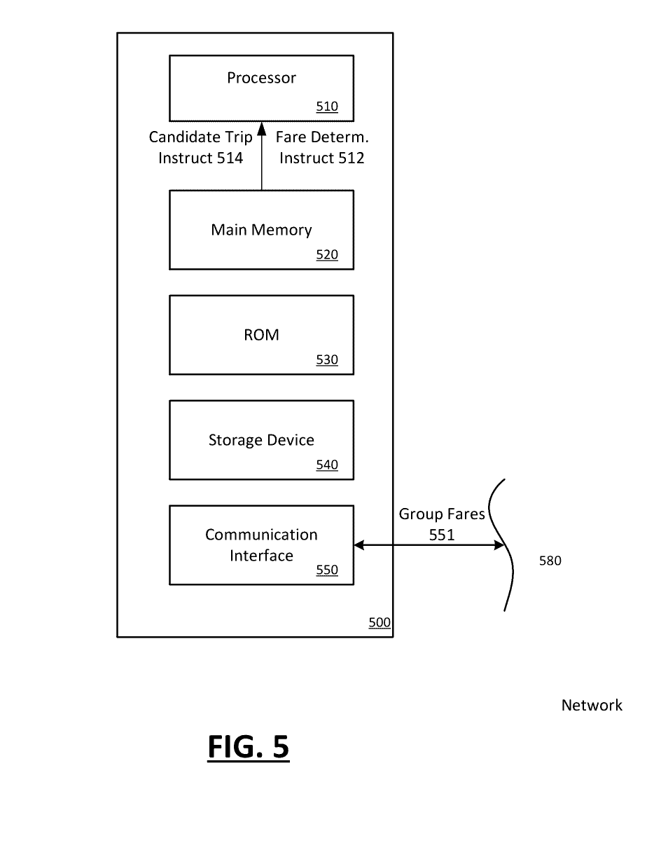

FIG. 5 is a block diagram that illustrates a computer system upon which embodiments described herein may be implemented. A computer system 500 can be implemented on, for example, a server or combination of servers. For example, the computer system 500 may be implemented as part of a network service for arranging transport services, or as part of a fare determination system or service for use with a service for arranging transport. In the context of FIG. 1, fare determination system 100 may be implemented using a computer system such as described by FIG. 5. The fare determination system 100 may also be implemented using a combination of multiple computer systems such as described by an example of FIG. 5.

In one implementation, the computer system 500 includes processing resources 510, a main memory 520, a read-only memory (ROM) 530, a storage device 540, and a communication interface 550. The computer system 500 includes at least one processor 510 for processing information stored in the main memory 520, such as provided by a random access memory (RAM) or other dynamic storage device, for storing information and instructions which are executable by the processor 510. The main memory 520 also may be used for storing temporary variables or other intermediate information during execution of instructions to be executed by the processor 510. The computer system 500 may also include ROM 530 or other static storage device for storing static information and instructions for the processor 510. A storage device 540, such as a magnetic disk or optical disk, is provided for storing information and instructions.

The communication interface 550 enables the computer system 500 to communicate with one or more networks 580 (e.g., cellular network) through use of the network link (wireless or a wire). Using the network link, the computer system 500 can communicate with one or more computing devices, and one or more servers. The executable instructions stored in the memory 520, the ROM 530, and/or the storage device 540 can include fare determination instructions 512 and candidate trip instructions 514. The fare determination instructions 512 can determine fares for different candidate trips of the rider. Among the fare calculations, the fare determination instructions 512 can calculate group fares 551 (including prospective fares, estimates etc.) for group transports, such as described with examples of FIGS. 1 through 4B. The candidate trip instructions 514 can determine alternative trips for a rider based on a transport input which includes or indicates at least one of the pickup or drop-off locations, and is indefinite as to other trip information.

The processor 510 is configured with software and/or other logic (shown with instructions 512, 514) to perform one or more processes, steps and other functions described with implementations, such as described by FIGS. 1 through 4B, and elsewhere in the application.

Examples described herein are related to the use of the computer system 500 for implementing the techniques described herein. According to one embodiment, those techniques are performed by the computer system 500 in response to the processor 510 executing one or more sequences of one or more instructions contained in the main memory 520. Such instructions may be read into the main memory 520 from another machine-readable medium, such as the storage device 540. Execution of the sequences of instructions contained in the main memory 520 causes the processor 510 to perform the process steps described herein (e.g., determine group price 551 or candidate trip fare 553). In alternative implementations, hard-wired circuitry may be used in place of or in combination with software instructions to implement examples described herein. Thus, the examples described are not limited to any specific combination of hardware circuitry and software.

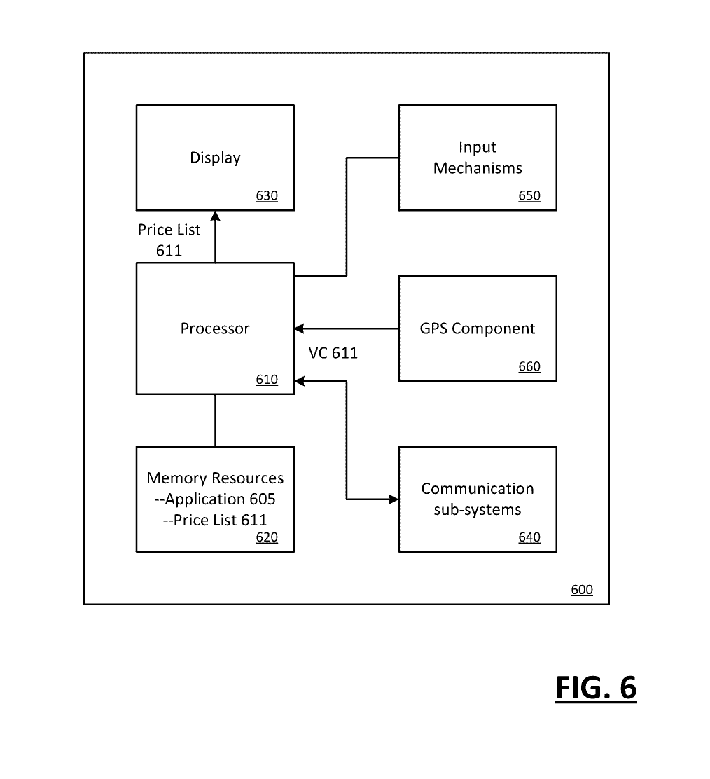

FIG. 6 is a block diagram that illustrates a mobile computing device upon which embodiments described herein may be implemented. In one embodiment, a mobile computing device 600 may correspond to, for example, a cellular communication device (e.g., feature phone, smartphone etc.) that is capable of telephony, messaging, and/or data services. In variations, the mobile computing device 600 can correspond to, for example, a tablet or wearable computing device. Still further, the mobile computing device 600 can be distributed amongst multiple portable devices of a driver.

In an example of FIG. 6, the computing device 600 includes a processor 610, memory resources 620, a display device 630 (e.g., such as a touch-sensitive display device), one or more communication sub-systems 640 (including wireless communication sub-systems), input mechanisms 650 (e.g., an input mechanism can include or be part of the touch-sensitive display device), and one or more location detection mechanisms (e.g., GPS component) 660. In one example, at least one of the communication sub-systems 640 sends and receives cellular data over data channels and voice channels.

The memory resources 620 can store one or more applications (service application 605) for linking the mobile computing device 600 with a network service that enables or otherwise facilitates transport services provided through the driver. The mobile computing device 600 can receive a price list 611 from a network service via one of the communication subsystems 640 (e.g., cellular interface). The processor 610 can display the price list 611 for multiple candidate trips of a rider. The price list 611 can also include a fare for a group transport rate, based on predicted variables such as group size.

While examples of FIG. 5 and FIG. 6 provide for a computer system 500 and mobile computing device 600 for implementing aspects described, in some variations, the mobile computing device 600 can operate to implement some or all of the functionality described with the fare determination system 100.

What is claimed is:

1. A method for arranging transport, the method being implemented by one or more processors and comprising:
processing a transport input from a rider for a group transport, the transport input including information that indicates at least one of a pickup or drop-off location;
determining at least one trip for the transport input;
determining a probability of a group size for the group transport for one or more segments of the at least one trip;
determining at least one fare for the at least one trip based on the group size; and
communicating the at least one fare to the rider in advance of receiving a transport request from the requester.

2. The method of claim 1, further comprising:
charging the fare to the rider in response to the rider selecting to receive the at least one trip within a given duration of time from when the at least one fare is determined.

3. The method of claim 1, wherein processing the transport request includes determining at least one of the pick up or drop-off location based on historical information about the rider.

4. The method of claim 1, wherein the historical information includes one or more of (i) a drop-off location that is marked by the rider as being a favorite location; (ii) a set of one or more recent or most recent drop-off locations;
and/or (iii) a set of one or more most common drop-off locations.

5. The method of claim 1, wherein processing the transport request includes (i) determining a current location of the rider using position information communicated from a mobile computing device of the rider, and (ii) using historical information about the rider to determine one or more drop-off locations.

6. The method of claim 5, wherein the historical information includes one or more of (i) a drop-off location that is marked by the rider as being a favorite location; (ii) a set of one or more recent or most recent drop-off locations;
and/or (iii) a set of one or more most common drop-off locations.

7. The method of claim 1, wherein processing the transport request includes determining multiple possible trips for the rider in response to the transport request, and wherein determining at least one fare includes determining multiple fares, including a fare for each of the multiple possible trips.

8. The method of claim 1, wherein determining the probability of the group size includes determining whether the group size will include either one or two riders, based at least in part on historical data that is relevant to the transport request.

9. The method of claim 1, wherein determining the at least one fare for the at least one trip includes applying a rule to define a range for the fare.

10. The method of claim 1, wherein determining the group size includes determining a probability of an additional rider sharing at least a portion of the transport before a group transport is provided to the rider.

11. The method of claim 1, wherein determining the group size includes determining a probability of an additional rider sharing at least a portion of the transport after a group transport is provided to the rider.

12. The method of claim 1, further comprising:
controlling a programmatic resource on a mobile computing device of the rider in order to cause the mobile computing device of the rider to transmit information that is inferential as to a user's interest or intent for making a particular request for transport.

13. The method of claim 12, wherein the programmatic resource includes a service application which communicates with a network service for arranging transport.

14. The method of claim 13, wherein the transmitted information includes data indicating the rider has just launched the service application on a mobile computing device of the rider.

15. The method of claim 13, wherein the transmitted information includes data indicating the rider is viewing an application page of the service application.

16. The method of claim 13, wherein the transmitted information includes sensor data obtained from a sensor of the mobile computing device of the rider, wherein the sensor data indicates a level of interaction as between the rider and the mobile computing device of the rider.

17. A computer system comprising:
a memory to store instructions;
one or more processors to access the instructions from memory in order to perform operations that include:
processing a transport input from a rider for a group transport, the transport input including information that indicates at least one of a pickup or drop-off location;
determining at least one trip for the transport input;
determining a probability of a group size for the group transport for one or more segments of the at least one trip;
determining at least one fare for the at least one trip based on the group size; and
communicating the at least one fare to the rider in advance of receiving a transport request from the requester.

18. The computer system of claim 17, wherein one or more processors determine the group size by determining a probability of an additional rider sharing at least a portion of the transport after a group transport is provided to the rider.

19. The computer system of claim 17, wherein the one or more processors access the instructions from memory in order to perform operations that include:
controlling a programmatic resource on a mobile computing device of the rider in order to cause the mobile computing device of the rider to transmit information that is inferential as to a user's interest or intent for making a particular request for transport.

20. A non-transitory computer-readable medium that stores instructions, which when executed by one or more processors, cause a system of the one or more processors to perform operations that include:
process a transport input from a rider for a group transport, the transport input including information that indicates at least one of a pickup or drop-off location;
determine at least one trip for the transport input;
determine a probability of a group size for the group transport for one or more segments of the at least one trip;
determine at least one fare for the at least one trip based on the group size; and
communicate the at least one fare to the rider in advance of receiving a transport request from the requester.
